(19) United States
(12) Patent Application Publication
(10) Pub. No.: US 2004/0095029 A1
(43) Pub. Date: May 20, 2004

(54) Multifunctional housing piece for an electrical motor

(76) Inventors: Andreas Ewert, Lichtenau (DE); Frank Kopf, Ottersweier (DE); Jens Ulrich, Gaggenau (DE); Jochen Goehre, Karlsruhe (DE); Thomas Helming, Baden-Baden (DE); Bernd Wieland, Gaggenau (DE)

Correspondence Address: Striker Striker & Stenby, 103 East Neck Road, Huntington, NY, 11743, US

(21) Appl. No.: 10/381,537

(22) PCT Filed: Jun. 5, 2002
(86) PCT No.: PCT/DE02/02039

(30) Foreign Application Priority Data
Jul. 31, 2001 (DE) 101373716

(51) Int. Cl. H02K 5/08

(52) U.S. Cl. 310/89; 310/90; 310/91

(57) ABSTRACT

The invention is based on a method for producing a common carrying part (3) for an electrical drive, whereby a bottom region (2) is formed on the common carrying part (3) that can be produced having various axial lengths and diameters,

wherein the functional areas for power supply (14, 15; 26), stator field-generation (12, 13), support (4, 5, 23) and housing add-ons (6) for higher-level systems are capable of being integrated on the common carrying part (3) in arbitrary combinations.

### TECHNICAL FIELD

Internal combustion engines are used in motor vehicles, with which a number of electrical machines are used, such as starters, alternators, fan motors, etc. Electrical drives such as fans in motor vehicles are usually composed of a large number of separately-produced subassemblies, such as a power supply part and a mounting part, or field-generating components, brush holder, bearing components, or parts for generating the electrical field, such as magnets, permanent magnets, or field coils.

### BACKGROUND OF THE INVENTION

Electrical drives for fans in motor vehicles usually comprise separate subassemblies, e.g., for power supply (brush holder or EC printed circuit board). Furthermore, an electrical drive is to be equipped with the mount for a bearing, as well as with ribs, grooves or springs in the housing part for immobilizing the parts for generating the stator field, e.g., permanent magnets or field coils. Since these parts are accommodated in the housing of the electrical drive, components must be built in to immobilize the permanent magnets or field coils in the housing in torsion-proof fashion. Moreover, a cover element is required on the housing, with which a second bearing accommodating a rotor shaft is supported in the housing of the electrical drive. Moreover, further housing parts are required, such as a cable routing or a plug connection.

Until now, electrical drives for fans installed in motor vehicles were assembled out of many individual parts composed of different materials. Every individual subassembly must be kept separate during assembly of the electrical drive; a plurality of suppliers must be kept on hand for each subassembly, and enormous logistical expenditure is required to stockpile and furnish these subassemblies.

Material-dependent assembly and/or joining operations are required for the subassemblies, which are composed of different materials. This results in additional assembly costs. If a carrying part designed to meet the requirements of a plurality of functionalities is produced as the housing of a fan or another electrical machine out of a plurality of separate subassemblies, this can result in match-up problems at interfaces when complex components are involved, because the subassemblies do not all come together until final assembly.

Every subassembly is produced in and of itself in separate production and/or machining steps in which adherence to tolerance is ensured. In the worst-case scenario, however, extremely unfavorable tolerances can add up in final assembly, which means the match-up problems at the individual subassembly interfaces mentioned hereinabove can set in.

### ADVANTAGES OF THE INVENTION

The advantages capable of being obtained with the solution according to the invention lie in the fact that, when a common carrying part of an electrical machine or an electrical drive of a fan for use in automotive applications is produced, functional areas can now be produced in various combinations and with various levels of integration. The four basic areas that are realized on a common carrying part can be further characterized as power supply (internal and external), stator field generation, support, and housing add-ons.

The common carrying part is preferably produced in a shaping process such as metal diecasting, plastic injection molding, or sheet metal working. Nearly any shaping process—chip-forming or non-chip-forming—can be used. When the process of plastic injection molding is used, the common carrying part can be produced in various levels of integration—with regard for realizing the components of the four basic functional areas on the common carrying part—by changing the injection-molding tool on the plastic injection-molding machine.

The functional areas mentioned hereinabove that can be formed on a common carrying part are power supply, stator-field generation, support, and housing add-ons.

Power supply (internal and external) comprises components such as EC electronics, the brushes of a brush-commutated motor, and interference-suppression elements. The brushes of a brush-commutated motor can be housed in receptacles that are integrated in the common carrying part. The components of the external power supply include a mains connection or an outgoing attachment plug.

Components for generating the stator field, such as magnets or field coils, flux rings or the like, are mounted in the common carrying part by means of mounting elements with which the components listed hereinabove for generating the stator field can be immobilized in the common carrying part; the flux ring can be installed as a separate ring, or it can be mounted on the pot-shaped element covering the components for generating the stator field. Stator field-generation is a functional area as well.

A further functional area within the common carrying part, the “support” function, is performed by a bearing element integrated in the common carrying part, for which a bearing seat can be provided on the common carrying part during its production. The bearing can be held directly by the carrying part, or it can be mounted in the common carrying part by means of an additional component such as a bearing support or a wave spring washer or another immobilizing element.

A further function that can be realized on the common carrying part is referred to as “housing add-ons”. “Housing add-ons” can refer to the air routing when fans are involved (inlet funnel), or the fastening device for the higher-level system, e.g., the frame of a radiator module. A fastening device for a higher-level system on the common carrying part can be located in a connection with a ring frame as the inserted fan in the radiator module for an internal combustion engine.

The components that the common carrying part is prepared to house, depending on the integration level selected, can be mounted in the common carrying part by means of snapping, pressing, bonding or screwing them into place.

The common carrying part is used to equip a motor vehicle, e.g., in conjunction with electrical drives, adjusting drives, water pumps, or power-steering pumps, and it is used as an inserted fan housing in radiator modules of internal combustion engines in motor vehicles or commercial vehicles.

### SUMMARY OF THE DRAWINGS

The invention will be described in greater detail hereinbelow with reference to the drawing.

FIG. 1 is a view of a common carrying part with mounting components for the power supply and stator field-generation functions,

FIG. 2 is a view of a common carrying part with mounting components for the power supply and support functions,

FIG. 3 is a view of a common carrying part with mounting components for the power supply components and housing add-on functions,

FIG. 4 is a view of a common carrying part with the stator field-generation and support functional areas,

FIG. 5 is a view of a common carrying part with the stator field-generation and housing add-on functional areas,

FIG. 6 is a view of a common carrying part with the support and housing add-on functional areas,

FIG. 7 is a view of a common carrying part with the power supply, stator field-generation and support functional areas,

FIG. 8 is a view of a common carrying part with the power supply, stator field-generation and housing add-on functional areas,

FIG. 9 is a view of a common carrying part with power supply, support and housing add-on functional areas,

FIG. 10 is a view of a common carrying part with the stator field-generation, support and housing add-on functional areas, and

FIG. 11 is the highest level of integration of a common carrying part with the power supply, stator field-generation, support and housing add-on functional areas.

### DESCRIPTION OF THE PREFERRED EMBODIMENTS

The following levels of integration—presented in summary form in the following table—are available based on the four basic (functional areas) on a carrying part containing components and/or mounting elements for electrical add-on devices.

| | | Stator Field- | | Housing |
|---|---|---|---|---|
| No. | Power Supply | Generation | Support | add-ons |
| 1 | X | X | | |
| 2 | X | | X | |
| 3 | X | | | X |
| 4 | | X | X | |
| 5 | | X | | X |
| 6 | | | X | X |
| 7 | X | X | X | |
| 8 | X | X | | X |
| 9 | X | | X | X |
| 10 | | X | X | X |
| 11 | X | X | X | X |

The figures, each of which represents one integration level, are listed in chronological order in the table above.

The common carrying part 3—which is capable of being developed in various levels of integration—is produced in a shaping process such as metal diecasting, plastic injection molding, or sheet metal working. The individual components and functions—which can be integrated in the common carrying part 3 in any combination in accordance with the table above—are outlined briefly hereinbelow.

A first functional area called “power supply”—in accordance with the overview presented in the table hereinabove—in the common carrying part 3 can contain snap-in hooks 14 that serve to secure EC electronics. It also includes receptacles 15 that accommodate brushes, when brush-commutated electric motors are involved. In addition, a mains connection or outgoing attachment plugs 26 as well as interference-suppression elements in the interior of the common carrying part 3 can be associated with these mounting elements 14, 15 that are capable of being integrated on the common carrying part 3. The mounting elements 14 and/or 15 serve the internal part of the power supply, while the mains connection and/or the outgoing attachment plug 26 are associated with the external power supply of an electrical drive housed in the common carrying part 3. The receptacles 15 can be integrally molded on the common carrying part 3, or they can be formed on the circumference of a bearing seat 23 in the bottom region 2 of the common carrying part 3. It is also possible to design the receptacles 15 for holding brushes as integrally-molded structural parts, and to design them as separate, individual components that are equipped with the brushes after they are assembled and installed.

The components on the common carrying part 3 that can be assigned to the “stator field-generations” functional area can comprise, e.g., the mounting elements 12, 13 or mounting projections for the field-generating components 10, such as magnets, field coils, flux rings or the like. With said components, the field-generating components 10 can be immobilized axially substantially parallel to the symmetry axis 1 of the common carrying part 3.

The “support” functional area in the overview presented in the table hereinabove can include bearing components such as rolling bearings, plain bearings, plastic cylinder liners, bearing supports, wave spring washers and the like, which said bearing components can be either pressed, snapped, or screwed into a bearing seat 5 in the bottom region 2 of the common carrying part 3, or they can be bonded therewith. They serve to accommodate the rotating parts of the electric motor in the common carrying part 3 of the electrical add-on device. It is also possible to integrally mold or extrude the bearing bolt supporting the rotor on the stator, i.e., on the common carrying part 3, as an integration level especially for use with electronically-commutated motors, or for similar designs in which the rotor is situated around the stator, i.e. the common carrying part 3 in the present application.

The “housing add-ons” functional area in the overview presented above in the table comprises additional functional elements that can also be provided on the common carrying part 3. They include, for example, air routings when fans (air funnels) are involved, or fastening elements for attachment to higher-level systems, e.g., a ring frame in the case of inserted fans for radiators of motor vehicles, which said inserted fans are also referred to as air scoops, for use in either in car or truck applications.

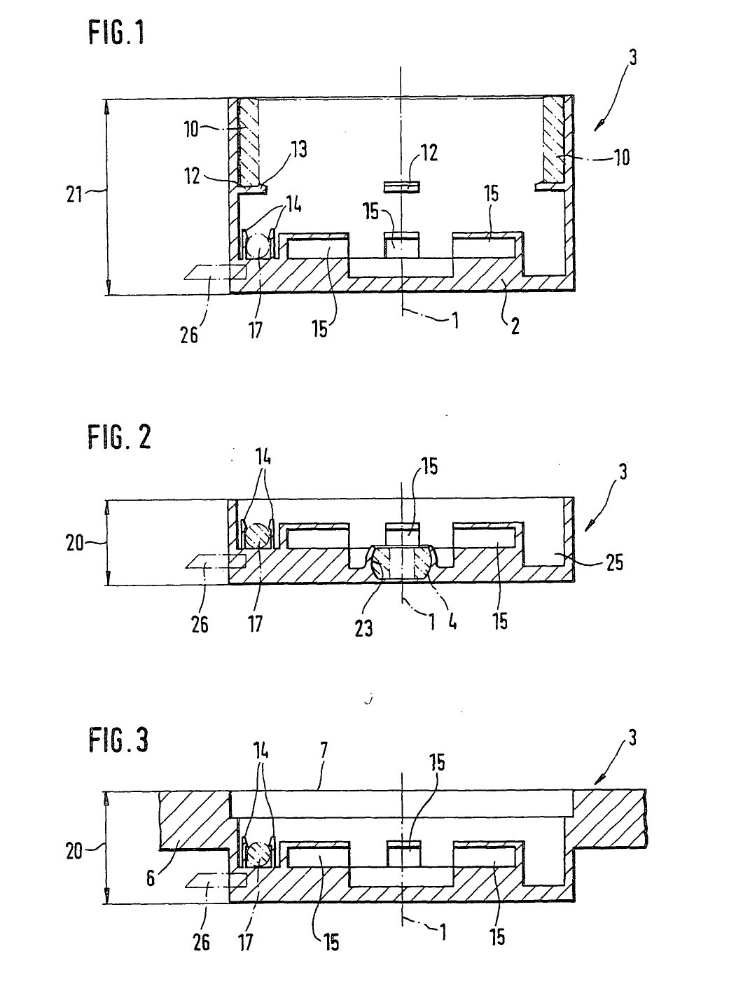

FIG. 1 is a view of a common carrying part with mounting components for the power supply and stator field-generation functional areas.

The functional elements associated with the “power supply” functional area, e.g., receptacles 15 for holding carbon brushes, are formed on the bottom region 2 of the common carrying part 3. The receptacles 15 for holding carbon brushes can be located with an angular displacement around the symmetry axis 1 that is defined by the number of poles in the electrical drive used. In addition, snap-in hooks 14 can be associated with the “power supply” functional area, which said snap-in hooks grip around the interference-suppression elements such as reactors or capacitors 17. Additionally, the “power supply” functional area also comprises the external power supply in the form of a connecting element 26 designed as cable plug or mains connection. In FIG. 1, the “stator field-generations” functional area is realized in the form of clips 12, to which a lock-in projection 13 or a pull-back rib can be assigned. These mounting elements serve to axially immobilize stator field-generating components 10, e.g., magnets, field coils, flux rings or the like. The common carrying part 3 can be designed having an axial length 21 that can be entirely variable; furthermore, the diameter of the common carrying part 3 can also be configured in flexible fashion depending on the particular installation requirement.

FIG. 2 is a view of a common carrying part 3 with mounting elements for the power supply and support functional areas.

According to the integration level of the common carrying part 3 shown in FIG. 2, the “support” functional area—in the form of a bearing seat 5, 23 in which a bearing body 4 is housed—is integrated in the bottom region 2 of the common carrying part 3 in addition to the “power supply” functional area, which contains components 15, 14 and 26. The bearing body 4 can be designed as a rolling bearing or a plain bearing that can be pressed, bonded or clamped in the bearing seat 23 of the common carrying part 3. This integration level can be designed having various axial lengths 20 as well as various diameters, depending on the particular application.

FIG. 3 is a view of a common carrying part with mounting elements for the power supply and housing add-on functional areas.

In addition to the “power supply” functional area developed on the common carrying part 3 according to this integration level, the “housing add-ons” functional area is also realized in this exemplary embodiment. The common carrying part 3 created in accordance with this exemplary embodiment is preferably interconnected with an air scoop 6, e.g., with a radiator module, whereby the electric motor driving the radiator blower can be housed in the common carrying part 3. The flux ring-which is a component of the stator field components 10—can be recessed in the ring surface 7 of the common carrying part 3 shown in FIG. 3.

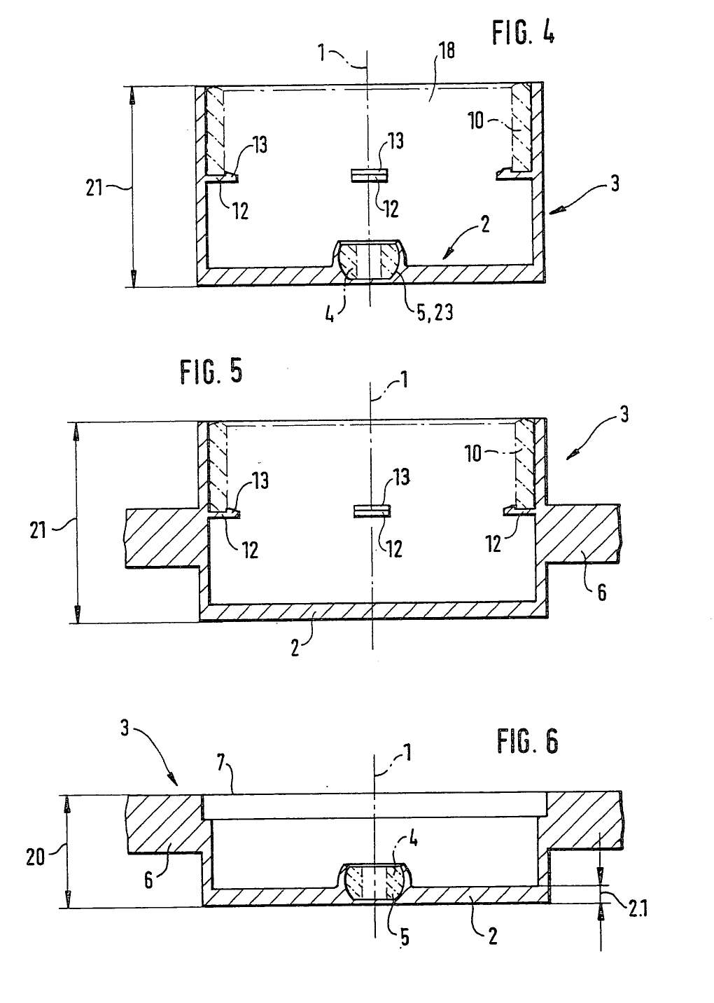

FIG. 4 shows a view of a common carrying part on which the “stator field-generation” and “support” functional areas are formed.

According to the illustration in FIG. 4, clips 12 with optional lock-in projections 13 are formed in the interior of the common carrying part 3. Furthermore, a bearing body 4 is cast, engaged, bonded or pressed in the bottom region 2 of the common carrying part 3. The bearing body 4 is enclosed in a bearing seat 5, 23 in the common carrying part 3. A cavity 18 houses the armature—not shown in FIG. 4—of the electric motor in the common carrying part 3.

FIG. 5 is a view of a common carrying part with the “stator field-generation” and “housing add-ons” functional areas.

Analogous to the exemplary embodiment according to FIG. 4, clips 12 are cast or integrally extruded in the interior of the common carrying part 3, which said clips are equipped with a protruding lock-in projection or pull-back rib 13 on their radially in-board ends for immobilizing stator field-components 10 such as permanent magnets or field coils in the axial direction. According to this exemplary embodiment, an air scoop 6 to a radiator module can be integrally extruded on the outside of the common carrying part 3, making it an integral part of a radiator module that can be installed on an internal combustion engine of a motor vehicle.

FIG. 6 is a view of a common carrying part with the “support” and “housing add-ons” functional areas.

The “housing add-ons” functional area is designed in the shape of an air scoop 6 as a connection to a higher-level system, while the “support” functional area is realized in the form of a bearing body 4 that is recessed in a bearing seat 5 in the bottom region 2 of the common carrying part 3. The wall thickness of the bottom region 2 is labelled with reference numeral 2.1; the common carrying part 3 according to the exemplary embodiment in FIG. 6 is designed having an axial length 20 that can be varied, of course.

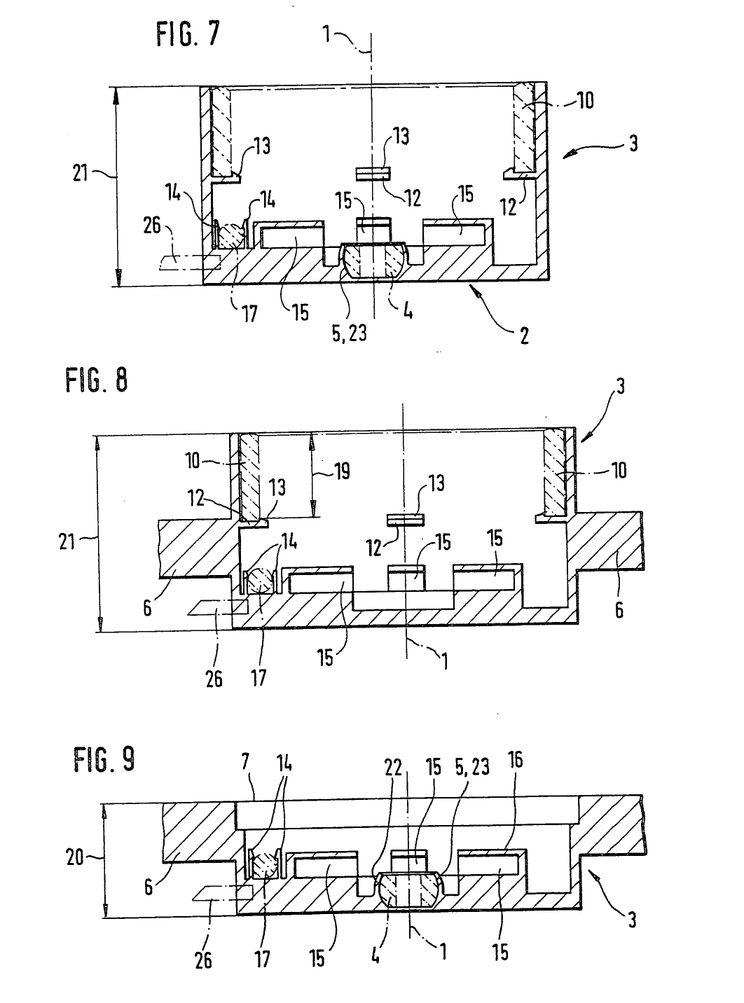

FIG. 7 is a view of a common carrying part with the “power supply”, “stator field-generation” and “support” functional areas.

The “power supply” functional area is realized in the form of the components 15 designed as receptacles to hold carbon brushes, and in the form of snap-in hooks 14 that serve to accommodate interference-suppression elements such as reactors or capacitors 17. The components listed hereinabove are associated with the internal power supply, while a cable plug or a mains connection 26 serves as external power supply for the electric motor housed in the common carrying part 3. The “stator field-generations” functional area is formed by clips 12 with optional lock-in projections 13 that serve to immobilize stator field-generating components such as permanent magnets 10 in the axial direction. A bearing body 4 that is enclosed in a bearing seat 5, 23 is integrated in the bottom surface 2 of the common carrying part 3 as a realization of the “support” functional area.

FIG. 8 is a view of a common carrying part with the “power supply”, “stator field-generation” and “housing add-ons” functional areas.

The “power supply” functional area is realized in the form of components 14, 15 (internal) and the mains connection 26 (external power supply). In this exemplary embodiment, the “stator field-generations” function is realized in the form of clips 12 with lock-in projections 13 provided radially on said clips. Said clips can be located at a distance 19 from an end face of the common carrying part 3 that corresponds to the axial length of the components for stator field-generation 10. The “housing add-ons” functional area is realized in the form of a frame or air scoop 6 by way of which the common carrying part 3 is interconnected with a radiator module—not shown here in entirety and that can be created as a plastic injection-molded part, for example—and is cast therein.

FIG. 9 is a view of a common carrying part with the “power supply”, “support”, and “housing add-ons” functional areas.

In the integration level of the common carrying part 3 shown in FIG. 9, the internal/external “power supply” functional area is realized in the form of the receptacles 15 for the carbon brushes to be housed therein, and in the form of the snap-in hooks 14 in which interference-suppression elements 17 are mounted. The external part of the “power supply” functional area is indicated in the form of an outgoing plug attachment or mains connection 26, shown only as a schematic drawing in this illustration. The “housing add-ons” functional area is designed in the form of an air scoop or a frame 6 with which the exemplary embodiment of the common carrying part 3 according to the illustration in FIG. 9 can be integrated in a radiator module not shown here in greater detail.

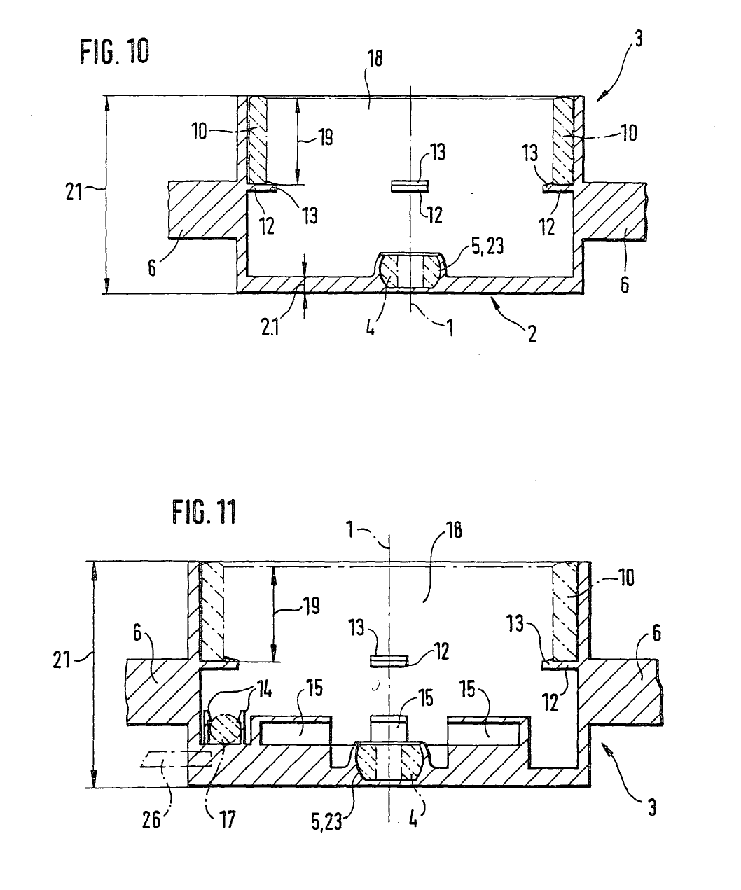

FIG. 10 is a view of a common carrying part with the “stator field-generating”, “support”, and “housing add-ons” functional areas.

According to this integration level of the common carrying part 3, the “stator field-generating” functional area is developed in the form of clips 12—optionally equipped with lock-in projections 13—that can be developed in the interior of the common carrying part 3 offset in relation to each other at an angle determined by the number of poles in the electrical drive used. The clips 12 in which the stator field-generating components 10—such as magnets, field coils and flux rings or the like—are mounted are located at a distance 19 from an end face of the common carrying part 3 that can correspond to the axial length of the stator field-generating components 10, for example. The “support” functional area is realized in the form of a bearing body 4 that is mounted in a bearing seat 5, 23 in the bottom region 2 of the common carrying part 3. The “housing add-ons” functional area in the integration level of the common carrying part 3 shown in FIG. 10 is realized in the form of an air scoop or an air funnel 6, with which the common carrying part 3 can be integrated in a radiator module for an internal combustion engine without any additional connection components.

FIG. 11 is a view of the highest integration level of a common carrying part having the “power supply”, “stator field-generation”, “support”, and “housing add-ons” functional areas.

The carrying part 3 according to the illustration in FIG. 11 can be produced using diecasting, plastic injection molding, and sheet metal forming and pressing.

An air scoop 6 (or ring frame) is integrally cast or extruded on the outer circumference of the substantially cylindrically configured carrying part 3. The fastening openings in said air scoop (or ring frame) make it possible to mount the carrying part 3 on other components that are not shown in the drawing in FIG. 11. A projection 12 is integrated in the common carrying part 3 in the interior of a cavity 18 opposite the air scoop 6, which said projection serves to axially and radially secure components 10 for generating a stator field. In place of a projection 12 designed in the shape of a nose, pull-back ribs or other mounting elements—oriented in the axial direction—for the components 10 for generating a stator field can be provided within the common carrying part 3. The components 10 for generating a stator field can be created in an axial length 19 and can be enclosed entirely by the common carrying part 3; a shorter design of the components 10 for generating a stator field is possible as well.

The bottom region 2 of the common carrying part 3 according to the exemplary embodiment in FIG. 11 can be designed in multiple planes, and it can comprise a bearing seat 5 and/or 23 that encloses a bearing body 4, be it a plain bearing or a rolling bearing. These components form the “support” functional area.

Receptacles 15 for holding carbon brushes are formed at a right angle to the symmetry axis 1 of the common carrying part 3. Snap-in hooks 14 are located next to said receptacles, which said snap-in hooks can be integrally cast or extruded in the bottom region 2 of the common carrying part 3. Brushes of brush-commutated electric motors can be accommodated in the receptacles 15. The “power supply” functional area, i.e., its internal part, is realized in the form of the components 14 and 15.

The external power supply, which is also associated with the “power supply” functional area, is formed by a mains connection or an outgoing plug attachment 26, shown as a schematic drawing in this illustration.

The “support” functional area is realized in the highest integration level according to the illustration in FIG. 11 in the form of a bearing seat 5, 23 in the bottom region 2 of the common carrying part 3. A bearing body 4 is pressed, clamped, or calked in the bearing seat 5, 23.

The “stator field-generating” functional area is realized in the form of clips 12—optionally equipped with lock-in projections or pull-back ribs 13—integrally cast or molded on the peripheral wall of the cavity 18 in the interior of the common carrying part 3. These mounting components situated in the interior of the common carrying part 3 immobilize field-generating components 10 for generating a stator field in the interior of the common carrying part 3. They can be permanent magnets, magnets, as well as coil windings or field coils. Depending on the axial length of the common carrying part 3—which can be flexible depending on the particular requirement—field-generating components 10 having different axial lengths 19 can be mounted in the interior of the common carrying part. The cavity 18 serves to house an armature (not shown in greater detail here) of an electric motor in the interior of the common carrying part 3.

The “housing add-ons” functional area is realized in the highest integration level 11 in the form of an air scoop and/or an air funnel 6, with which the common carrying part 3 can be integrated in a radiator module (not shown in entirety here) or a pump housing, e.g., an automotive water pump.

According to the integration—depicted in conjunction with FIGS. 1 through 11—of a plurality of functionalities of a carrying part produced using a shaping process, components and functions can be integrated in the carrying part 3 in arbitrary combinations. If a carrying part 3 is produced using a shaping process, e.g., metal diecasting or plastic injection-molding—especially in the case of electronically commutated motors, in which the rotor is situated around the stator—the bearing bolt, for the rotor in particular, can be provided on the carrying part 3 directly on the housing.

### List of Reference Numerals

| | |
|---|---|
| 1 | Symmetry axis |
| 2 | Bottom region |
| 2.1 | First wall thickness |
| 2.2 | Second wall thickness |
| 3 | Common carrying part |
| 4 | Bearing body |
| 5 | Bearing seat |
| 6 | Air scoop, air funnel |
| 7 | Ring surface |
| 10 | Field-generating components (permanent magnets, coil winding) |
| 12 | Clip |
| 13 | Projection, pull-back rib |
| 14 | Snap-in hook |
| 15 | Receptacle |
| 17 | Interference-suppression elements (reactors, capacitors) |
| 18 | Cavity (for armature) |
| 19 | Winding length, magnet length |
| 20 | First height |
| 21 | Further height |
| 23 | Bearing seat |
| 26 | Power supply (mains connection, outgoing attachment plug) |

What is claimed is:

1. A method for producing a common carrying part (3) for an electrical drive, whereby a bottom region (2) is formed on the common carrying part (3) that can be produced having various axial lengths and diameters,
wherein the functional areas for power supply (14, 15; 26), stator field-generation (12, 13), support (4, 5, 23) and housing add-ons (6) for higher-level systems are capable of being integrated on the common carrying part (3) in arbitrary combinations.

2. The method according to claim 1, wherein the functional areas for power supply (14, 15, 26) and stator field-generation (12, 13) are formed on the common carrying part (3).

3. The method according to claim 1, wherein the functional areas for power supply (14, 15; 26) and support (4, 5, 23) are formed on the common carrying part (3).

4. The method according to claim 1, wherein the functional areas for power supply (14, 15; 26) and housing add-ons (4, 5, 23) are integrated on the common carrying part (3).

5. The method according to claim 1, wherein the functional areas for stator field-generation (12, 13) and support (4, 5, 23) are integrated on the common carrying part (3).

6. The method according to claim 1, wherein the functional areas for stator field-generation (12, 13) and housing add-ons (6) are integrated on the common carrying part (3).

7. The method according to claim 1, wherein the functional areas for support (4, 5, 23) and housing add-ons (6) are integrated on the common carrying part (3).

8. The method according to claim 1, wherein the functional areas for power supply (14, 15, 26), stator field-generation (12, 13) and support (4, 5, 23) are integrated on the common carrying part (3).

9. The method according to claim 1, wherein the functional areas for power supply (14, 15, 26), stator field-generation (12, 13) and housing add-ons (6) are integrated on the common carrying part (3).

10. The method according to claim 1, wherein the functional areas for power supply (14, 15; 26), support (4, 5, 23) and housing add-ons (4, 5, 23) are integrated on the common carrying part (3).

11. The method according to claim 1, wherein the functional areas for stator field-generation (12, 13), support (4, 5, 21) and housing add-ons (6) are integrated on the common carrying part (3).

12. The method according to claim 1, wherein the functional areas for power supply (14, 15; 26), stator field-generation (12, 13), support (4, 5, 23) and housing add-ons (6) are integrated on the common carrying part (3).

13. The method according to one or more of the preceding claims, wherein the common carrying part (3) is produced and shaped using the metal diecasting method.

14. The method according to one or more of the preceding claims, wherein the common carrying part (3) is produced and shaped using the plastic injection-molding method.

15. The method according to one or more of the preceding claims, wherein the common carrying part (3) is produced and shaped by means of sheet-metal forming and pressing.

16. The method according to one or more of the preceding claims, wherein the common carrying part (3) is used to house electrical drives for adjustment gearsets, fluid pumps, fans, radiator modules in motor-vehicle/commercial vehicle applications.
